(19) United States
(12) Patent Application Publication
(10) Pub. No.: US 2005/0259271 A1
(43) Pub. Date: Nov. 24, 2005

(54) Assembly and method for the optical-tactile measurement of a structure

(76) Inventor: Ralf Christoph, Schoeffengrund (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/380,467

(22) PCT Filed: Sep. 19, 2001
(86) PCT No.: PCT/EP01/10826

§ 371 Date: Mar. 20, 2003

(30) Foreign Application Priority Data
Sep. 20, 2000 (DE) 100 46 819.5
Oct. 2, 2000 (DE) 100 49 122.7

(51) Int. Cl. G01B 11/24

(52) U.S. Cl. 356/601

(57) ABSTRACT

Arrangement for performing the opto-tactile measurement of structures of an object using a coordinate measuring device that includes a scanner with a probe extension that is elastic on at least one side and with a scanning element extending therefrom that senses the object, an optical sensor that detects the scanning element directly or indirectly, such as a camera, and possibly a first lens that is arranged between the sensor and the scanner, where the scanner is adjustable together with the optical sensor. The optical sensor and the scanner are integrated into a single unit.

The invention relates to an arrangement for carrying out the opto-tactile measurement of structures of an object using a coordinate measuring device comprising a scanner with a scanner extension that is flexible at least on its ends and is equipped with a scanning element extending therefrom that senses the object, an optical sensor that detects the scanning element directly or indirectly, such as a camera, and a first lens that may be arranged between said optical sensor and the scanner, wherein the scanner can be adjusted jointly with the optical sensor. The invention further relates to a method for carrying out the opto-tactile measurement of structures of an object using a coordinate measuring device comprising a scanner with a scanner extension that is flexible at least on its ends and is equipped with a scanning element extending therefrom that senses the object, an optical sensor that detects the scanning element directly or indirectly, such as a camera, and a first lens that may be arranged between said optical sensor and the scanner.

The process of measuring structures of an object using a coordinate measuring device with electro-magnetically operated, i.e. switching, scanners is known in the art; with said scanners the position of the structure is determined directly, i.e. the position of the sensory element, such as a sphere, is transmitted via a scanner. However, the deformations of the scanner that occur during this process as a result of the acting frictional forces frequently lead to distortions of the measuring results. The strong transfer of force also results in measuring forces that are typically >10 mN. The geometric design of such scanning systems as a rule limits them to a spherical diameter of >0.3 mm. The three-dimensional measurement of small structures in the range of just a few 10^{ths} of a millimeter and the scanning of highly deformable samples are therefore problematic or impossible. Due to the influences of errors, which are not completely known, caused by the deformation of the scanner and scanning element, and due to the sensory forces, which are unknown because of e.g. stick-slip effects, measuring uncertainties arise, which are typically >1 μm.

A correspondingly mechanical scanning coordinate measuring device is disclosed e.g. in DE 43 27 250 A1. The visual control of the mechanical scanning process can be accomplished with the help of a monitor, in which the sensor head is observed via a video camera. The sensor head, which extends from a magnetic interchangeable support, may be in the form of a so-called piezoelectric quartz scanner, which upon contact with a workpiece surface is damped. The video camera thus allows the position of the probing sphere relative to the workpiece or bore that is to be measured to be observed on the monitor in order to monitor the scanning process manually when the bore is entered. The actual measuring process, however, takes place electro-mechanically.

U.S. Pat. No. 4,972,597 describes a coordinate measuring device with a probe, the extension of which is biased in its position via a spring. A section of the probe extension that extends within a housing is equipped with two light-emitting elements, positioned a certain distance from one another, for detecting WI the position of the probe extension via a sensory element, and thus indirectly detecting the position of a probing element that is positioned on the outer end of the probe extension.

To avoid the disadvantages of electro-mechanically operated switching scanners, WO 98/57121 proposes a coordinate measuring device for opto-tactile measurement. Here, the position of a scanning element that comes into contact with an object that is to be measured is determined optically in order to measure the structure directly from the position of the scanning element itself or from a reticule that is assigned to it. The excursion of the scanning element can be detected by sliding the image on a sensory field of an electronic image processing system with an electronic camera.

It is also possible to determine the excursion of the scanning element by evaluating a contrast function of the image via an electronic image processing system. Another possibility for determining excursion consists in determining it from an order of magnitude of the image of a reticule, resulting in a beam-optical connection between the object distance and enlargement.

Corresponding probes have an elastic extension, wherein the probe extension tapers down toward the scanning element, which is preferably designed as a sphere. The probe extension beyond the tapered end can have e.g. a diameter of 200 μm. At its end region the scanner extension can have a diameter of between 20 μm and 30 μm. Typical diameter dimensions of spherical scanning elements are between 30 and 500 μm.

The scanning elements disclosed in WO 97/57121 may be comprised of various materials such as ceramics, ruby, or glass. Furthermore the optical quality of the corresponding elements can be improved through coatings with dispersing or reflecting layers.

From DE 198 47 711 A1 we know of an opto-tactile coordinate measuring device, wherein the optical sensor and the probe form a jointly adjustable unit, wherein the probe extends from an interchangeable support and is connected via an optical and mechanical coupling to an adjustment device for the interchangeable support, which can be adjusted relative to or with the interchangeable support in a rotatory and translatory manner. The optical sensor itself is stationary relative to the interchangeable support.

The present invention is based primarily on the task of further developing an arrangement and a method of the type described above in which the structure of an object can be measured to the extent required with a high degree of accuracy, ensuring in particular that the object does not interrupt the direct beam path between the scanning element and the sensor. Measuring should be possible even under unfavorable optical conditions.

Pursuant to another aspect of the invention, the scanning element should make it possible to perform measurements in the x, y and z directions of the coordinate measuring device simultaneously. A high level of measuring accuracy should also be achieved, with optical aberrations, which lead to distortions of the measurements, being excluded. In particular, the measuring of minute or relatively deep openings such as through-holes should be possible without risking damage to the probe.

For a basic resolution of the task, it is proposed pursuant to one aspect of the invention that the optical sensor and the scanner be integrated into one unit or form such a unit. The unit can be adjustable via a positioner joint. Furthermore, the unit should comprise the first lens, designed in particular as a zoom lens with a possibly adjustable working distance. Conventional lenses of coordinate measuring devices that use opto-tactile measuring processes can of course be used as well.

Due to the fact that the scanner and the optical sensor with a lens are integrated into one unit and as such can be adjusted randomly in space via a positioner joint, it is possible to use this coordinate measuring device to measure areas that extend e.g. in an x-y plane or diagonally to it, such as orifices or bores, since the optical sensor is adjusted to the structure based upon to the orientation of the scanner.

The connection of the unit, consisting of the scanner, the lens, and the optical sensor with the positioner joint, can take place e.g. through a standard interchangeable interface. It is also possible, of course, for the probe to extend from an interchangeable support, as is described in DE 198 47 711 A1, hence that disclosure is hereby referenced. An interface between the lens and the sensor is also feasible, resulting in a modular set-up for the unit as a whole.

The lens that is used can, as mentioned, be a zoom lens, which may be designed with changeable working distances, as is described in WO 99/53268.

Further, the unit can contain a lighting device for the scanning element, wherein the scanning element can be illuminated directly or via the scanner extension as an optical waveguide.

In a further development of the invention that should be mentioned, a second optical sensor or a second lens is allocated to the scanning element or a marking assigned to it, with which the scanning element or the marking can be measured in an axis (such as the z-axis) that extends vertically relative to the plane (such as the x-y plane) that is being measured by the first optical sensor. This offers the opportunity of performing three-dimensional measurements using the scanning element.

In order to be able to conduct measurements even under unfavorable optical conditions or in an extremely precise manner, a suggestion pursuant to the invention provides for the scanning element to be equipped with a reflecting and/or fluorescing layer exclusively on its side that faces away from the sensor, and/or to be equipped with a layer consisting of reflecting or fluorescing material such that beams reflected by the surface of the layer on the side of the scanning element will create an optically detectable mark in the interior of the scanning element, such as a bright light spot.

These measures allow the precise measurement even of objects that are highly reflective since a mark generated in the scanning element is used for measurement, rather than the point of contact between the scanning element and the object. When the layer extends exclusively on the side of the scanning element that faces away from the sensor, i.e. in a scanning element having a spherical geometry maximally to its equator, it is ensured that abrasion of the layer due to contact between the scanning element and the object is suppressed.

Pursuant to another proposal of the invention, independent of the degree to which the layer extends across the scanning element, the layer is covered at least in its area that comes into contact with an object by a surface-hardened or abrasion-resistant protective coating, especially a protective coating containing silicone, such as a silicone-nitride layer.

If a mark can be generated in the scanning element through the reflection of light, a further notable development provides for a marking that appears in the first optical sensor as a mark of the scanning element to extend from the probe extension, wherein the position of the scanning element can be determined using the mark.

For example, a discoid element, whose projection in the direction of the scanning element is smaller than its extension in the plane that is to be measured, can extend from the scanning element. To measure the object in the z-direction of the coordinate measuring device, an excursion of the scanning element in the z-direction can be determined as an excursion of the mark to the scanning element.

Thus, pursuant to the invention, the alignment of the scanning element in the z-direction is determined from the change in the distance of the image of the mark, i.e. of the mark to the image of the scanning element. A conversion then place using a measuring curve between the excursion and the change in distance.

In particular, the scanning element should have a spherical geometry and the marking a cylindrical geometry, wherein in the case of scanning elements without excursion the mark would clearly extend in the center of the scanning element.

Generally the sensing of an object is determined by sliding the image of the sensory element on the sensor field of the optical sensor or of the image processing system. However with this, measuring errors can occur due to aberrations of the lens incorporated between the sensory element and the optical sensor. In order to exclude corresponding depiction errors, one proposal of the invention suggests that the scanning element that is to be measured in one plane (x-y plane) be moved to the sensory point of the object that is to be measured, such that initially a rough sensory process occurs so as to then move the sensory element back until the image is located at the starting point of the sensor field in which the image is located when not in contact with the object. This measure enables precise measurements of the sensory point without resulting in optically-related measuring errors.

To measure especially bores of minute diameter at desired depths without running the risk of damaging the probe or the probe extension or the scanning element, one proposal of the invention, which is covered by protection separately and independently, provides for the probe measuring in one plane (x-y plane) to be adjustable immediately prior to or immediately following contact of the object vertically or roughly vertically to the plane, i.e. in the sensory direction.

Through the vertical or nearly vertical movement toward the sensory direction at a distance of e.g. 1 μm, particularly at a distance of between 1 μμm and 20 μm, to the sensory point, adhesive powers between the scanning element and the object are overcome, which otherwise would cause the scanning element to remain attached to the object across an undesirably long adjusting path for the probe, with the consequence that the probe would oscillate during a sudden detachment. When measuring minute orifices this can cause the probe or its extension or the scanning element to impact on the opposite boundary wall and possibly be destroyed.

If through-holes in the wall of a hollow body as the object are to be measured, the invention proposes that a lighting device be arranged in the hollow body, which creates light that is directed parallel to the longitudinal axis of the probe extension intersecting with the scanning element. In this way, simple design measures can ensure that the through-holes can be measured at high cycle sequences without necessitating adjustment between the individual measurements.

To determine sensory points with high level of measuring accuracy, the above-mentioned method for conducting opto-tactile measurements of structures of an object is characterized by the fact that the scanning element measures a mark to determine the position of the scanning element. The mark can be generated by depicting a marking extending from the probe in and/or relative to the image of the scanning element. In particular, the mark should run through the center of the scanning element if there is no contact with an object that is to be measured.

Using a mark that is allocated to the scanning element, it is possible to measure an object in the z-direction of the coordinate measuring device, wherein the scanning element experiences an excursion in the z-direction, and the excursion of the scanning element in the z-direction is calculated from the relative displacement between the scanning element and the mark or its images. The relative displacement can here be determined from the distance between the center of the image of the scanning element and the center of the mark.

In order to overcome possible adhesive forces between the scanning element and the object, one suggestion pursuant to the invention provides for the probe to be adjusted vertically or roughly vertically relative to the plane that intersects with the sensory point at a distance x to the sensory point when the sensory element approaches a sensory point and/or after traveling away from a sensory point, wherein the distance x should be 1 μm≦x≦20 μm.

Pursuant to another proposal of the invention, to measure through-holes in the walls of a hollow body an illuminating device is positioned in the hollow body such that light is aligned parallel to the longitudinal axis of the probe extension intersecting with the scanning element that measures a through-hole. In this process, the illumination position remains unchanged when measuring the through-holes of the hollow body one after the other.

In order to eliminate depiction-related measuring errors, which can arise from aberrations of the lens, one autonomous solution provides for the scanning element to scan the object that is to be measured first in a rough manner and then be retracted such that the image of the sensory element detected by the optical sensor is located in a position (point of origin) that corresponds to the image position, without contact with the object.

The sensory process can occur at high speed, while the movement for reaching the point of origin positions takes place slowly.

Further details, benefits, and features of the invention are found not only in the claims, the features revealed in them—alone and/or in combination, but also in the following description of preferred embodiments depicted in the drawings.

They show:

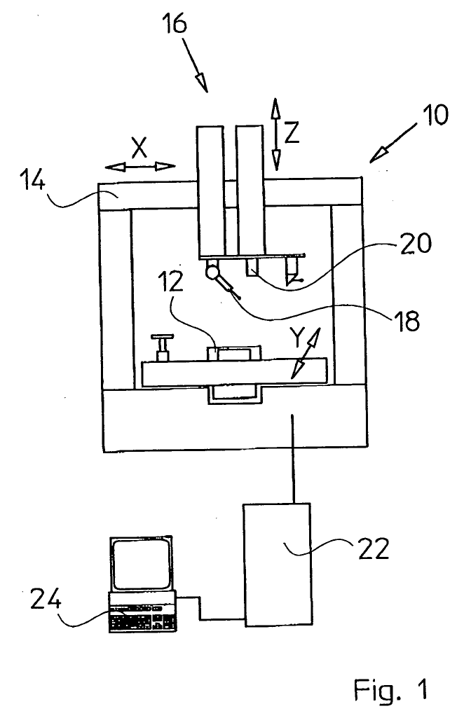

FIG. 1 a basic depiction of a coordinate measuring device,

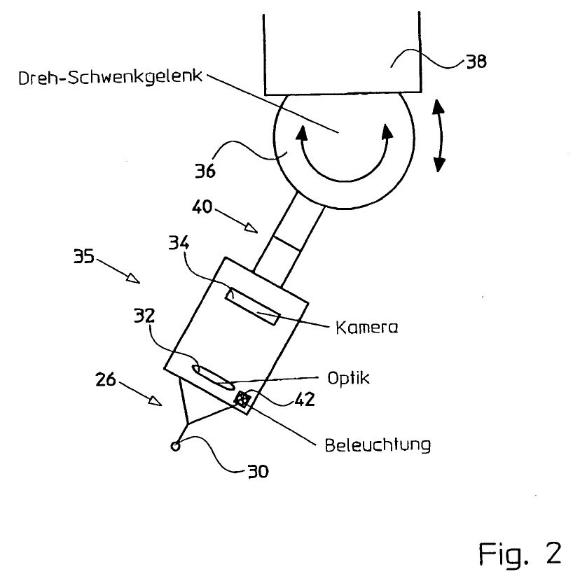

FIG. 2 a basic depiction of a section of the coordinate measuring device pursuant to FIG. 1 with scanners measuring in an opto-tactile manner,

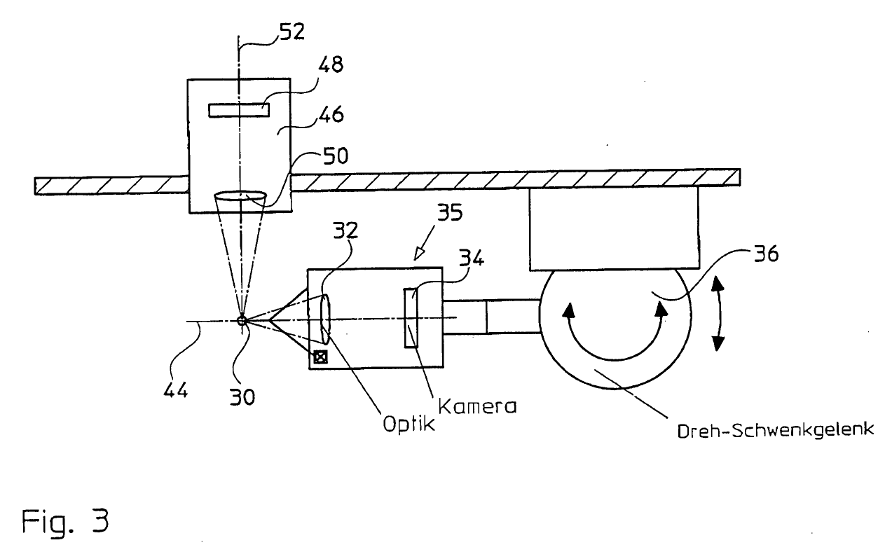

FIG. 3 a basic depiction of an arrangement for performing three-dimensional measurements with a scanner measuring in an opto-tactile manner,

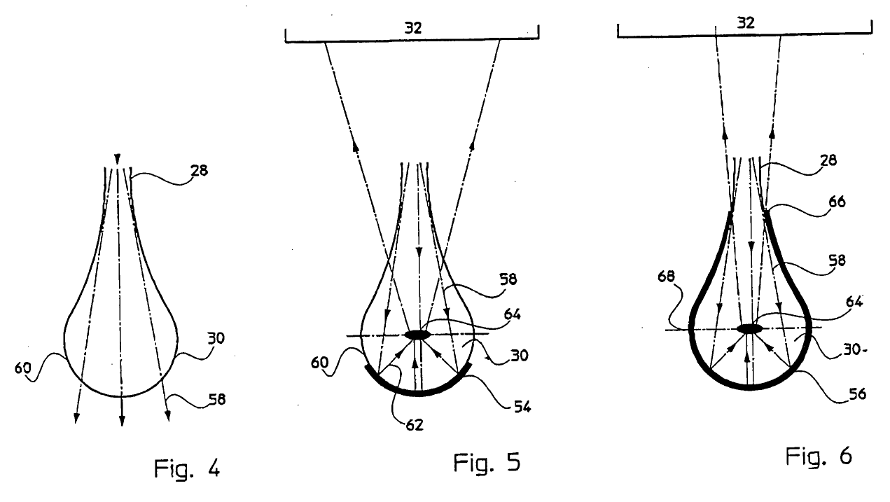

FIG. 4 a basic depiction of a scanning element,

FIG. 5 a first further development of the scanning element pursuant to FIG. 4,

FIG. 6 a second further development of the scanning element pursuant to FIG. 4,

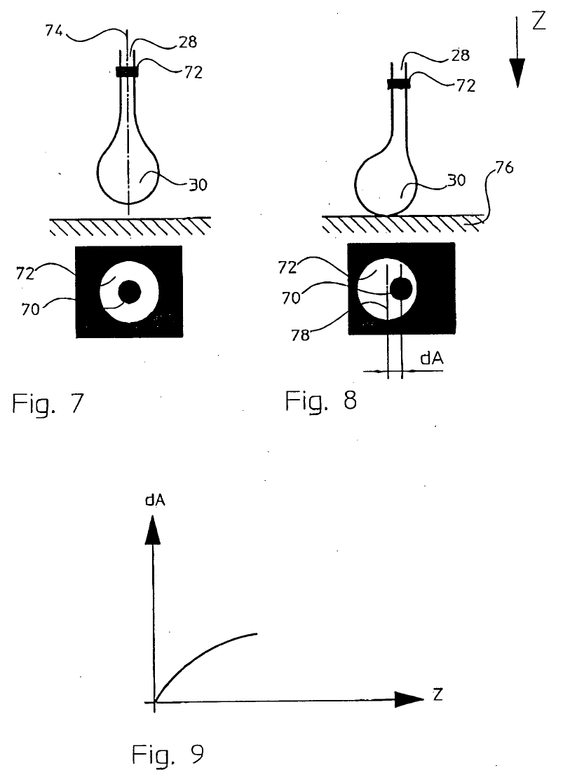

FIG. 7 a basic depiction of a scanning element with allocated marking,

FIG. 8 a basic depiction of the scanning element pursuant to FIG. 7 following excursion in the z-direction,

FIG. 9 a graph for determining the excursion of the scanning element in the z-direction,

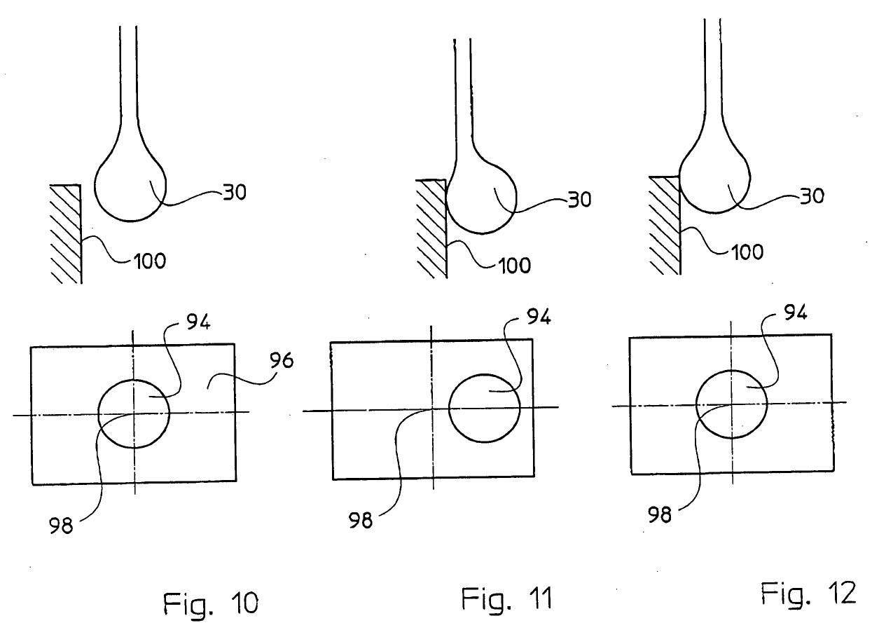

FIG. 10 a basic depiction of a scanning element that is arranged a certain distance from an object and its image,

FIG. 11 the scanning element revealed in FIG. 10 when coming into contact with the object, and the image of the scanning element,

FIG. 12 the scanning element pursuant to FIG. 11 in a retracted position, with the image of the scanning element,

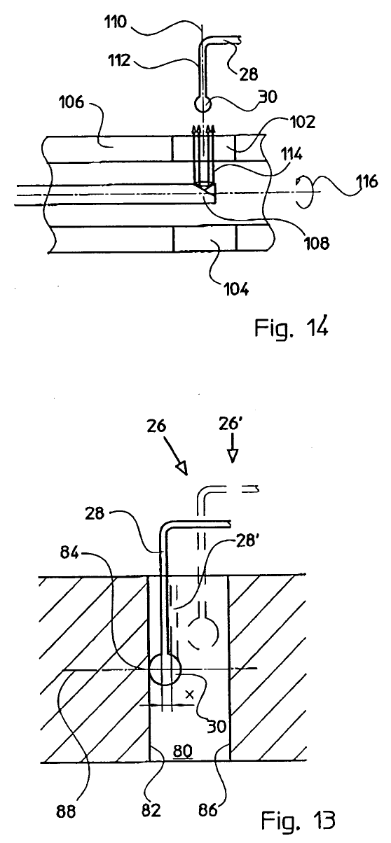

FIG. 13 a basic depiction of an arrangement for measuring an orifice of small diameter,

FIG. 14 a basic depiction of an arrangement for measuring through-holes in a hollow body,

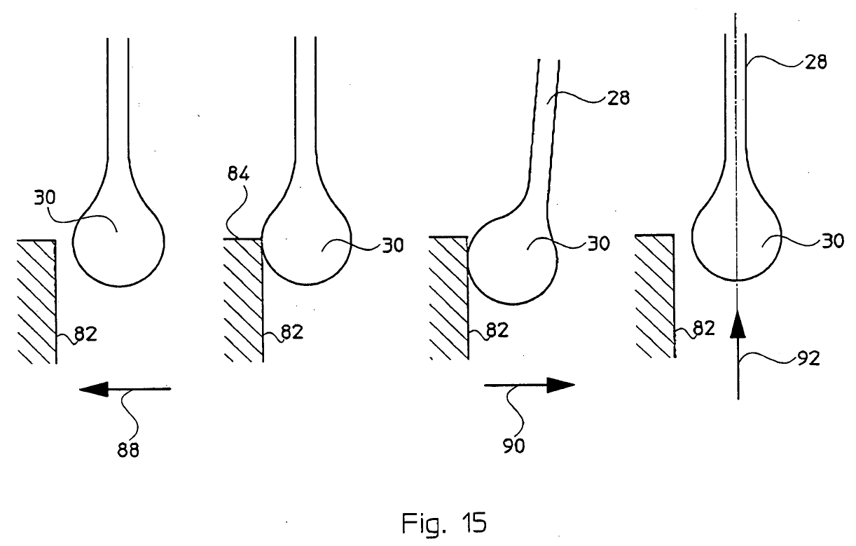

FIG. 15 various positions of a scanning element in relation to a sensory surface,

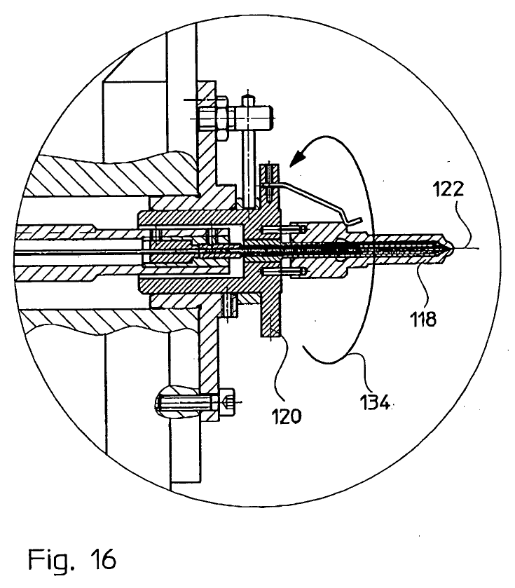

FIG. 16 a section of a rotatably seated injection nozzle, and

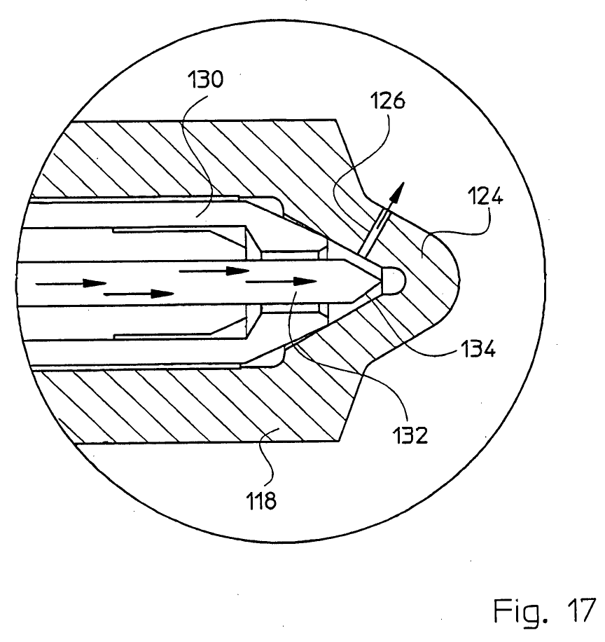

FIG. 17 the injection nozzle pursuant to FIG. 16 in a sectional view.

FIG. 1 shows a basic depiction of a coordinate measuring device 10—in the exemplary embodiment a multi-sensor coordinate measuring device—in a portal design, which is designed for use in measuring an object 12. For this the coordinate measuring device 10 contains a slide 16, which can be displaced along a portal 14 and from which spindles or sensors extend, for measuring the object. In the embodiment, the coordinate measuring device 10 contains at least one sensor 18 that measures in an opto-tactile manner, and a measuring lens 20 for measuring in the z-direction.

The coordinate measuring device 10 can be operated in a conventional manner using a data processing system 22 and a terminal 24. In this respect, however, we refer to familiar techniques, which also relate to the basic design of the coordinate measuring device 10.

To measure the structure of the object 12 in an opto-tactile manner a fiber scanner is used, which has been labeled with the number 26 and, pursuant to FIGS. 13 and 14, consists of a preferably L-shaped, bent probe extension 28 with a scanning element 30 on its end. The scanning element 30 is preferably a spherical body, without limiting the invention hereby. The probe elongation 28 is elastic at least on its ends and can consist of a light-guiding fiber. The cross-section of the probe extension 28 generally runs in the range of 200 μm, with the probe extension 28 having a cross-section of between 20 μm and 30 μm in the region of the scanning element 30. Depending upon the measuring tasks, the scanning element 30 has a diameter of roughly 30 to 50 μm if it is spherical in shape. In this respect, we explicitly refer to the disclosure of WO 98/57121 and in particular WO 99/53269, pursuant to which the probe elongation extends within the guiding device, and only its end section is freely movable. This offers the opportunity of specifying defined sensory forces.

To detect the sensory process of the object 12, the scanning element 30 is depicted onto an electronic camera and/or its sensor field such as a CCD matrix via a lens 37. In this respect we also refer to the familiar techniques from the applicant. Instead of detecting the scanning element 30, it is also possible to select a reticule that is assigned to it and extends from the probe elongation 28 as a reference point. For purposes of simplification, however, the scanning element 30 shall herein be used only for measuring purposes, without serving to limit the scope of the invention. The corresponding explanations also apply to a reticule that is allocated to the scanning element 30.

When the scanning element 30 comes into contact with the object, this process is detected by sliding the image on the sensor field of the sensor 34, and is thus measured.

Pursuant to the state of the art, the sensor and scanner 26 are adjusted as a unit, however the sensor measures basically parallel to the x-y plane. Pursuant to the invention, the camera 34, the lens 32, and the scanner 26 are designed as a unit 35, which is connected to a positioner joint 36, which in turn can extend from a sleeve 38 of the coordinate measuring device 10. The positioner joint 36 allows the unit 35 to be positioned with regard to its angle in the working space of the coordinate measuring device 10. Due to this, the camera 34 or its image plane can assume desired positions relative to the object 12 so that e.g. undercuts and in particular orifices that extend parallel to the x-y plane, such as bores, can be measured. The unit 35 can be connected to the positioner joint via a standard interchangeable support 40. It is also possible to connect the scanner 26 to the unit 35 via a scanner interchangeable station, such as the one described in DE 198 47 711 A1.

Further, the unit 35 should contain an illuminating device 42, which illuminates the scanning element 30 directly or via the probe extension 28, which is designed as a light guide.

The lens 32 can also be a zoom lens, possibly with an adjustable working distance, such as is described in WO 99/53268, the disclosure of which is hereby expressly referenced.

Due to the fact that the unit 35 comprising the sensor 34, the lens 32, and the scanner 26 is connected to a positioner joint 36, it is also possible to measure the scanning element 30 not only in one plane such as the x-y plane, but also along an axis running vertically thereto, i.e., in the case of the x-y plane, the z-axis. This shall be explained with the help of FIG. 3.

The unit 35 is aligned parallel to the x-y plane of the coordinate measuring device 10 relative to the optical axis 44 via the positioner joint 36. The position of the scanning element 30 can then be measured via the measuring lens 20, 46 comprising a sensor 48 and a lens 50, such as a zoom lens with variable working distance, wherein in the embodiment the optical axis 52 of the measuring lens 46 coincides with the z-axis.

In order to be able to perform measurements even under unfavorable optical conditions and/or on objects that are highly reflective, such as mirror or metal surfaces, pursuant to the invention the scanning element 30 contains a coating 56, 58 at least in some areas that consists of fluorescing or reflecting material.

As the basic depiction in FIG. 4 clarifies, light beams 58, which are guided via the probe extension 28, exit from the side 60 of the scanning element 30 facing away from the sensor in a substantially unimpaired manner. This can lead to problems in the depiction of the scanning element 30 on the optical sensor 34 or its sensor field. To prevent this, pursuant to the embodiment of FIG. 5, the scanning element 30 is equipped in its area 60 that faces away from the sensor with the coating 54, which reflects the beams 58 reaching the scanning element 30, wherein, due to the geometry of the exterior surface of the area of the scanning element 30 that faces away from the sensor and the correspondingly aligned coating 54, the reflected beams 62 are bundled into a luminous spot 64, which the optical sensor 34 can detect in a defined manner and can use to determine the position of the scanning element 30. Pursuant to the embodiment of FIGS. 5 and 6, the exterior geometry of the scanning element 30 is such that the reflected beams are reflected toward the center of the scanning element 30 where the luminous spot 64 is created.

If, pursuant to the embodiment of FIG. 5, the coating 54, as mentioned, extends only in the area 60 of the scanning element 30 that faces away from the sensor, so that upon contact with an object the layer 54 is outside the contact region and therefore no abrasion can occur, then the layer 56 pursuant to FIG. 6 extends to the start of the probe extension 28, while a peripheral edge 66 of the layer 56 is used as a collimator or entrance pupil for the beams 58 that reach the scanning element 30, which, pursuant to the embodiment of FIG. 5, are reflected to the center of the scanning element 30, where they form a bright luminous spot 64, which is depicted on the optical sensor 34 via the lens 32.

To prevent the layer 56, which may extend only to the equator 68 of the scanning element 30, from experiencing abrasion, an additional layer having a high surface hardness or abrasion resistance can be applied; this layer preferably consists of a silicon compound such as silicon nitride. Other suitable layers are also possible.

If in the embodiments of FIGS. 5 and 6 a mark that is depicted by the luminous spot 64, rather than the scanning element 30, is actually evaluated to determine the position of the scanning element 30 using the help of the optical sensor 34, then, pursuant to the embodiments of FIGS. 7 and 8, there is another possibility for using a mark 70 that is connected with the scanning element 36 to measure in particular an excursion of the scanning element 30 in the z-direction.

Pursuant to the embodiment, a ring- or disk-shaped marking 72 extends from the probe extension 28, wherein said marking extends in the center within the scanning element and thus also in the center of its image 72 in the case of a free scanning element 30, i.e. when the scanning element 30 does not sense an object, and a projection that is parallel to the optical axis 74, which should coincide with the center axis of the section of the probe extension that is located on the end and transitions into the scanning element 30 for an L-shaped running probe extension 28, if the scanning element 30 has a spherical geometry and thus a circular geometry in the direction of the optical axis 74.

When the scanner and thus the scanning element 30 are moved in the z-direction, and when a surface 76 of the object 12 is being sensed, then the probe extension 28 is adjusted laterally, with the consequence that the mark 70 formed by the marking 72 is shifted toward the center 78 of the image 72 of the scanning element 30, in the embodiment of FIG. 8 by the distance dA.

This shift then allows the excursion in the z-direction to be determined using previously conducted comparative measurements. The relation between the shift dA and the excursion in the z-direction is shown in principle in FIG. 9.

Thus, pursuant to the teaching of the invention, the coordinate system 10 that measures in an opto-tactile manner can be used to detect a structure of an object three-dimensionally.

As FIGS. 7 and 8 also clarify, the mark 70 depicted by the marking 12 should preferably contrast the scanning element 30 and have a darkening effect.

Independent of this, the mark 70 generated by the marking 12 can also be used for two-dimensional measurements when measuring a structure in a plane so that consequently not the position of the scanning element as such, but that of the mark 70 is evaluated.

To measure recesses such as bores 80 having extremely small diameters, one must ensure in particular that when detaching the scanning element 30 from a sensory surface 82 or from a sensory point 84 adhesion forces acting upon the scanning element 30 do not lead to a detachment from the measuring point 54 occurring only after a considerable distance has developed between the scanner 26 and the sensory surface 82, resulting in a risk that the probe extension 28 could vibrate causing the scanning element to impact with the opposite wall 86 of the bore, thus causing damage.

To solve this problem, the invention proposes that, especially when removing the scanner 26 from the sensory point 84, the scanner be moved vertically or essentially vertically to the sensory direction 88, thus ensuring a rapid detachment of the scanning element 30, excluding a vibrating of the scanner 26 in an undesirable scope. This motion of the scanner 26 vertically or nearly vertically to the sensory direction 88 upon detachment from the sensory point 84 is clarified by the dashed images in FIG. 13.

The motion of the scanner 26 vertically or nearly vertically to the sensory direction 88 should occur when the probe extension 28 has been adjusted by a distance X out of the position in which the scanning element 30 is moved out of the zero position, with the distance amounting to a few A, especially between 1 μm and 20 μm.

FIG. 13 shows the scanner 26, shown by solid lines, in a position in which the scanning element 30 comes into contact with the sensory point 84 without the influence of transverse forces. 28′ shows the probe extension 28 in a position in which the scanner 26 has already been moved opposite the sensory direction 88; the scanning element 30, however, is still attached to the sensory point 84 due to the acting forces of adhesion. In the position of the scanner 26′ indicated by dashed lines, the motion that has already occurred vertically or nearly vertically to the sensory direction is shown, wherein the scanning element 30 has become detached from the sensory point 84 and is located above the sensory plane in which the sensory direction 88 runs.

The above-described process is shown again in FIG. 15. In the left position, the scanning element 30 is located a distance from the sensory surface 82. In the subsequent depiction, the scanning element 30 comes into contact with the sensory surface 82 at the sensory point 84 in order to measure an edge or a surface 82. The scanner 26 is then moved away, in the direction that is opposite of the sensory direction 88 (arrow 90). The scanning element 30 hereby remains attached to the sensory surface 82, and the probe extension 28 is adjusted in the direction of the arrow 60. Then the motion that runs vertically or nearly vertically to the sensory direction 88 (arrow 92) takes place, with the consequence that the scanning element 30 is immediately detached from the sensory surface 82 and is aligned to the longitudinal axis of the probe extension 28.

Based on FIG. 10-12 an autonomous aspect of the invention shall be explained.

In the opto-tactile measuring process, through the positioning of the scanning element 30 or its image 94, the structure of the object 12 that is to be measured is determined on the sensory field 96 of the optical sensor 34. When the scanning element 30 is not in contact with the object 12, the image 94 is located in a defined point on the sensor field 96, which is labeled the point of origin 98. When the scanning element 30 comes into contact with a structure that is to be measured, such as a surface 100, then the image 94 moves away from the point of origin.

Due to the lens 32, which is positioned between the optical sensor 34 and the scanning element 30, optically related detection errors can occur, leading to measuring inaccuracies. It would therefore be beneficial to measure the position of the scanning element 30 at exactly the moment when the scanning element 30 comes into contact with the sensory surface 100. This is made possible pursuant to the invention in that the scanning element 30 initially scans the sensory surface 100 in a rough manner, causing the image 94 to shift to the point of origin 98. The probe and thus the scanning element 30 are then moved back until the image 94 is again in the point of origin or is aligned on it, as is clarified in FIG. 12. The sensory motion can be performed relatively quickly, while the retraction process should take place slowly in order to exclude errors that may be caused e.g. by adhesion forces.

FIG. 14 conveys another autonomous aspect of the teaching pursuant to the invention.

To measure through-holes 102, 104 of a hollow body 106, the invention provides for a light source 108 to be positioned within the hollow body 106 so as to emit light, which runs parallel to the longitudinal axis 110 of the section 12 of the probe extension 28 transitioning into the scanning element 30. Appropriate beams that are directed at the longitudinal axis 110 have been labeled with 114. In order to measure the various through-holes 102, the light source 108 then remains in the adjusted position, and the hollow body 106 is turned toward the light source 108 (arrow 114).

One example of such a measuring process is disclosed in FIGS. 16 and 17. In FIG. 16 an injection nozzle 118 is seated in a fastening device 120 as the hollow body so as to rotate the injection nozzle 118 around its longitudinal axis 122. In the top area 124 of the injection nozzle 118 through-holes 126 are arranged on a conical casing, wherein in the embodiment the axis of the cone coincides with the longitudinal axis 122 of the injection nozzle 118. An illuminating device 132 in the form of a light guide, via whose conical end face 134 light is irradiated in the direction of the axis of the through-hole 126, is then positioned in the central bore 130 of the injection nozzle 118. This direction coincides with the optical axis of the opto-tactile measuring system and with the longitudinal axis 110 of the angular end section 112 of the scanner 26. To measure the through-holes 126 arranged on the conical casing in sequence, it is now necessary only to rotate the injection nozzle 118 (arrow 134 in FIG. 16). This keeps the light guide 132 stationary.

1. Arrangement for performing the opto-tactile measurement of structures of an object (12) using a coordinate measuring device (10) that comprises a scanner (18, 26) with a probe extension (28, 112) that is elastic on at least one side and with a scanning element (30) extending therefrom that senses the object, an optical sensor (34) that detects the scanning element directly or indirectly, such as a camera, and possibly a first lens (32) that is arranged between this and the scanner, wherein the scanner is adjustable together with the optical sensor,
characterized in that the optical sensor (34) and the scanner (26) are integrated into one unit (35) and form such a unit.

2. Arrangement pursuant to claim 1, characterized in that the unit (35) is adjustable by a positioner joint (36) and in particular comprises the first lens (32) preferably designed as a zoom lens with possibly adjustable working distance.

3. Arrangement pursuant to claim 1 or 2, characterized in that the unit (35) contains a lighting device (32) for the scanner (26) or its scanning element (30).

4. Arrangement pursuant to claim 1, characterized in that the scanning element (30) or a marking that is assigned to it is allocated to a second optical sensor or a second lens, with which the scanning element or the marking can be measured in an axis (z-axis; 52) that extends vertically to the plane (x-y plane) measured by the first optical sensor.

5. Arrangement preferably pursuant to claim 1, characterized in that the scanning element (30) is equipped exclusively on its surface (60) that faces away from the sensor with a reflective and/or fluorescing coating (54) and/or contains a layer (56) consisting of reflective or fluorescing material in such a way that radiation that is reflected by the surface of the coating on the side of the scanning element creates an optically detectable mark (64) in the interior of the scanning element (30), such as a bright luminous spot.

6. Arrangement pursuant to claim 5, characterized in that the coating (54) runs up to or approximately up to the equator (68) of the scanning element on the surface (60) that faces away from the sensor in the case of a scanning element with spherical shape.

7. Arrangement pursuant to claim 5 or 6, characterized in that the coating (54, 56) at least in its area that comes into contact with the object (12), is covered with a surface-hardened or abrasion-resistant protective coating, in particular a silicon-containing protective coating such as a silicon nitride layer.

8. Arrangement preferably pursuant to one of the previous claims, characterized in that a marking (72) extends from the probe extension (28) of the scanner (26), and appears in the first optical sensor (34) as a mark (70) of the scanning element (30), wherein the position of the scanning element can be determined by the mark.

9. Arrangement pursuant to claim 8, characterized in that the projection of the marking (22) such as a disk element in the direction of the scanning element (30) is smaller than its extension in the measuring plane of the scanner (30).

10. Arrangement pursuant to at least one of the previous claims, characterized in that for measuring the object (12) in the z-direction of the coordinate measuring device (10) an excursion of the scanning element (30) in the z-direction can be determined via the displacement of the mark (70) relative to the scanning element (30) or its image (72).

11. Arrangement pursuant to at least one of the previous claims, characterized in that the mark (70) is a darkened area in the illuminated scanning element (30).

12. Arrangement pursuant to at least one of the previous claims, characterized in that in the case of a scanning element (30) without excursion, the mark (70) apparently extends in the center (78) of the scanning element.

13. Arrangement preferably pursuant to one of the previous claims, characterized in that the scanner (26) measuring in a plane (x-y plane) is adjustable vertically or roughly vertically to the plane in its distance x from a sensory point (84) that is to be measured.

14. Arrangement preferably pursuant to one of the previous claims, characterized in that upon moving away from the sensory point (84) the scanner (28) is adjustable in its distance x, in particular with 1 μm≦x≦20 μm, vertically or roughly vertically to the sensory direction (88) located in the plane.

15. Arrangement preferably pursuant to one of the previous claims, wherein the object (106, 118) is a hollow body with walls (124) that contain through-holes (102, 104, 126), characterized in that an illuminating device (108, 132) that generates light, which is directed parallel to the longitudinal axis (11) of the probe extension (112) intersecting with the scanning element (30), is arranged in the hollow body (106, 118), with the position of the illuminating device remaining unchanged with a rotation of the hollow body.

16. Method for conducting opto-tactile measurements of structures of an object using a coordinate measuring device (10) that comprises a scanner (18, 26) with a probe extension (28, 112) that is elastic at least on one side and has a scanning element (30) extending therefrom that senses the object, an optical sensor (34) that detects the scanning element directly or indirectly, such as a camera, and possibly a first lens (32) that is arranged between this and the scanner, characterized in that the scanning element (30) initially senses the object (100) that is to be measured in a rough manner and is then moved back so that the image of the sensory element, captured by the optical sensor (34), is in a position (point of origin: 98) that corresponds to the position of the image when not coming into contact with the object.

17. Method pursuant to claim 16, characterized in that the rough sensory process is performed at a higher speed of the scanner (26) than the retraction of the scanner in order to reach the point of origin image position in the optical sensor (34).

18. Method preferably pursuant to one of the previous claims, characterized in to determine the position of the scanning element (30) a mark (70) is measured by the scanning element (30).

19. Method pursuant to at least claim 18, characterized in that the mark (70) is created by depicting a marking (72) extending from the scanner (26) and/or its probe extension in and/or relative to the image (72) of the scanning element (30).

20. Method pursuant to at least one of the previous claims, characterized in that if there is no contact with the object (12, 76) that is to be measured, the mark (70) extends through the center (78) of the scanning element (30) or its image (72).

21. Method pursuant to at least one of the previous claims, characterized in that to measure the object (76) in the z-direction, the scanning element (30) experiences excursion in the z-direction, wherein the excursion of the scanning element in the z-direction is calculated from the relative displacement between the scanning element and the mark (70) or its images (70, 72).

22. Method pursuant to at least one of the previous claims, characterized in that the relative displacement is determined from the distance (dA) between the center (78) of the image of the scanning element (30) and the center of the mark (70).

23. Method preferably pursuant to one of the previous claims, characterized in that before approaching and/or moving away from a sensory point (84) of the object (82), the scanner (26) is adjusted vertically or roughly vertically to the sensory point that intersects with the measurement plane (88) at a distance x from the sensory point.

24. Method pursuant to at least claim 23, characterized in that the scanner (26) is adjusted vertically or roughly vertically to the sensory direction (88) at a distance x, with 1 μm≦x≦20 μm, from the sensory point (84).

25. Method preferably pursuant to one of the previous claims, characterized in that to measure the wall of a hollow body (106, 118) containing through-holes (102, 104, 126), an illumination device (108, 132) is positioned in the hollow body in such way that light is aligned parallel to the longitudinal axis (110) of the probe extension (112) that intersects with the scanning element (30), which measures a through-hole.

26. Method pursuant to claim 25, characterized in that for the sequential measuring of the through-holes (102, 104, 126), the hollow body (106, 118) is rotated, and the position of the illumination device (108, 132) is maintained unchanged relative to the hollow body.
